(19) United States
(12) Patent Application Publication
(10) Pub. No.: US 2023/0124899 A1
(43) Pub. Date: Apr. 20, 2023

(54) COGNITIVE COLLABORATING LEARNING USER EXPERIENCE INTERFACE

(71) Applicant: International Business Machines Corporation, Armonk, NY (US)

(72) Inventors: Fang Lu, Billerica, MA (US); Jeremy R. Fox, Georgetown, TX (US); Martin G. Keen, Cary, NC (US); Sarbajit K. Rakshit, Kolkata (IN)

(21) Appl. No.: 17/505,974

(22) Filed: Oct. 20, 2021

(51) Int. Cl. G09B 5/06; G09B 7/04; G06T 15/00; G06F 3/01; G02B 27/01

(52) U.S. Cl. CPC G09B 5/067; G09B 7/04; G06T 15/00; G06F 3/012; G02B 27/0172

(57) ABSTRACT

Disclosed embodiments provide a virtual learning environment by generating one or more virtual students (VS) to interact with a real student (RS). A real student is a live student, while virtual students are computer-generated and exist in the virtual learning environment. The virtual students interact with the real student and/or other virtual students, in order to facilitate a collaborative learning environment.

### FIELD

The present invention relates generally to computer-based education, and more particularly, to a cognitive collaborating learning user experience interface.

### BACKGROUND

Virtual learning environments provide educators with an efficient way to deliver lessons to students. Virtual learning has a number of tools such as videos, electronic documents, and interactive tests and quizzes. Educators can utilize these tools as part of lesson plans. A key advantage of virtual learning education is that it allows students to attend classes from any location of their choice. It also allows schools to reach out to a more extensive network of students, no longer being restricted by geographical boundaries. Additionally, virtual learning lessons can be recorded, archived, and shared for future reference. This enables students to access the learning material at a time of their choosing.

Another advantage of virtual learning can be reduced financial costs. In many cases, virtual learning can be far more affordable when compared with physical, in-person learning. With virtual learning, costs for items such as student transportation, student meals, and real estate may be reduced. Furthermore, with virtual learning, course and/or study materials are available online, creating a paperless learning environment which is more affordable, as well as also being beneficial to the environment.

Another advantage of virtual learning can be improved student attendance. Since virtual learning classes can be taken from home or location of choice, there are fewer chances of students missing out on lessons. As the aforementioned advantages of virtual learning become more compelling, virtual learning is becoming more accepted at all educational levels.

### SUMMARY

In one embodiment, there is provided a computer-implemented method comprising: obtaining a student profile for a real student; creating a virtual environment; generating a virtual student within the virtual environment; presenting a lesson to the real student in the virtual environment; and executing a virtual student interaction based on actions of the real student.

In another embodiment, there is provided an electronic computation device comprising: a processor; a memory coupled to the processor, the memory containing instructions, that when executed by the processor, cause the electronic computation device to: obtain a student profile for a real student; create a virtual environment; generate a virtual student within the virtual environment; present a lesson to the real student in the virtual environment; and execute a virtual student interaction based on actions of the real student.

In yet another embodiment, there is provided a computer program product for an electronic computation device comprising a computer readable storage medium having program instructions embodied therewith, the program instructions executable by a processor to cause the electronic computation device to: obtain a student profile for a real student; create a virtual environment; generate a virtual student within the virtual environment; present a lesson to the real student in the virtual environment; and execute a virtual student interaction based on actions of the real student.

### BRIEF DESCRIPTION OF THE DRAWINGS

FIG. 1 is an environment for embodiments of the present invention.

FIG. 2 is a flowchart indicating process steps for embodiments of the present invention.

FIG. 3 is a flowchart indicating additional process steps for embodiments of the present invention.

FIGS. 4A-4H illustrate examples of a virtual lesson.

FIG. 5 shows a data structure for a student profile in accordance with embodiments of the present invention.

FIG. 6 is a block diagram of a client device used with embodiments of the present invention.

FIG. 7 is a flowchart indicating additional process steps for embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the Figures may be omitted, or illustrated not-to-scale, for illustrative clarity.

### DETAILED DESCRIPTION

Disclosed embodiments provide systems and methods for virtual learning. Virtual learning provides a learning experience that is enhanced through utilizing computers and/or the Internet both outside and inside the facilities of the educational organization. The instruction most commonly takes place in an online environment. The teaching activities are carried out online whereby the teacher and learners are physically separated (in terms of place, time, or both).

Research shows that educational experiences that are active, social, contextual, engaging, and student-owned lead to deeper learning. The benefits of collaborative learning include development of higher-level thinking, oral communication, self-management, and leadership skills, promotion of student-faculty interaction, increase in student retention, self-esteem, responsibility, exposure to and an increase in understanding of diverse perspectives, and preparation for real life social and employment situations.

One current challenge with virtual learning is that it is not always possible to find required number of students for collaborative learning. Furthermore, even if willing participants exist, there is still a need to plan in advance to identify a common meeting time so that the participants can participate in the collaborative learning.

Disclosed embodiments address the aforementioned problems by generating one or more virtual students (VS) to interact with a user—a real student (RS). A real student is a live human student, while virtual students are computer-generated and exist in the virtual learning environment. The virtual students interact with the real student and/or other virtual students, in order to facilitate a collaborative learning environment. Virtual students can serve as “artificial humans” that engage with a real student to improve the learning experience by providing engagement and encouragement. In this way, disclosed embodiments improve the technical field of virtual learning.

In embodiments, the virtual learning may occur via a web conferencing system. In some embodiments, the virtual learning may occur in a virtual reality (VR) system. Virtual reality (VR) refers to a computer-generated process that immerses the user into a virtual environment. Using a device such as a VR headset, virtual reality provides a user with the sensation of a simulated world or environment.

Virtual reality is performed by stimulating various human senses. A major aspect of virtual reality is stimulating the visual senses. VR headsets are designed to create an immersive three-dimensional (3D) environment. VR headsets typically include the optics and electronics for rendering a display in front of eyes that displays a view of the virtual environment. Two autofocus lenses are generally placed between the screen and the eyes that adjust based on individual eye movement and positioning. The visual elements provided to the user on the screen are rendered by an electronic computing device such as a mobile phone or other connected computing device.

Another aspect of virtual reality is sound. Sound that is synchronized with the visual component can create very engaging effects. Headphone speakers, combined with audio processing to create directional sound effects, can help to provide an immersive experience.

Another aspect of virtual reality is head tracking. VR headsets may include devices such as accelerometers to detect three-dimensional movement, gyroscopes for angular movement, and/or a magnetic compass to identify the orientation of a user. As the user moves his/her head, the display and/or sounds presented to the user are updated in real time, making the user feel as if he/she is “looking around” in the virtual environment. Virtual reality technology can be used to enable various embodiments of the present invention.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

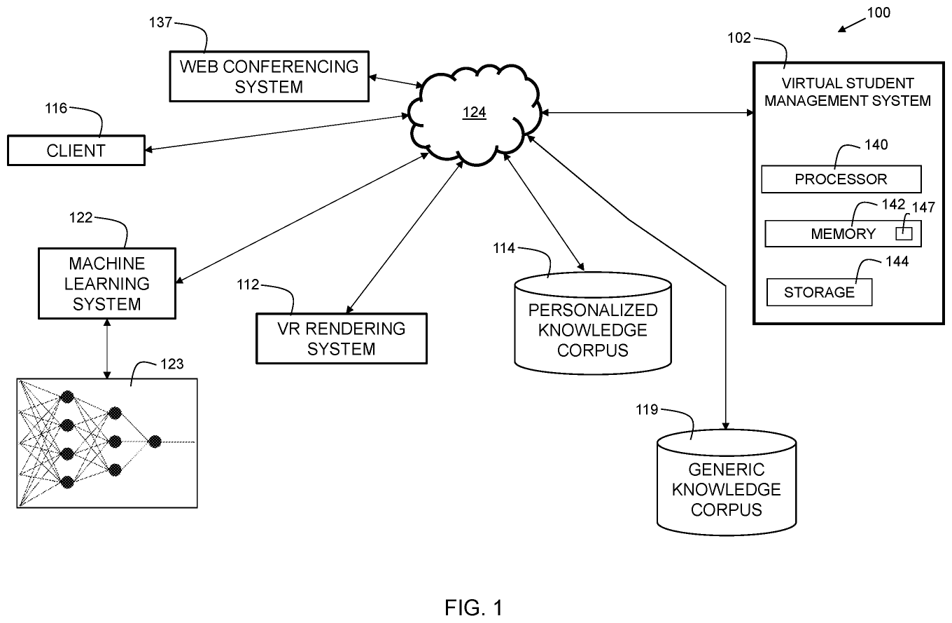

FIG. 1 is an environment 100 for embodiments of the present invention. Virtual Student Management (VSM) system 102 comprises a processor 140, a memory 142 coupled to the processor 140, and storage 144. System 102 is an electronic computation device. The memory 142 contains instructions 147, that when executed by the processor 140, perform processes, techniques, and implementations of disclosed embodiments. Memory 142 may include dynamic random-access memory (DRAM), static random-access memory (SRAM), magnetic storage, and/or a read only memory such as flash, EEPROM, optical storage, or other suitable memory. In some embodiments, the memory 142 may not be a transitory signal per se. In some embodiments, storage 144 may include one or more magnetic storage devices such as hard disk drives (HDDs). Storage 144 may additionally include one or more solid state drives (SSDs). The VSM system 102 is configured to interact with other elements of environment 100 in order to generate and utilize virtual students (VS) in virtual environments used for providing instruction to a real student (RS), also referred to herein as a user. The virtual students interact with the real student and/or other virtual students during a lesson, collaborative learning experience, breakout session, brainstorming session, or other collaborative experience. Real students vary widely in terms of personality, proficiency, and learning styles. Disclosed embodiments enable generation of an ideal number of virtual students as well as an ideal amount of participation by the virtual students, in order to stimulate the learning of a real student. Thus, disclosed embodiments enable educators to provide an individually tailored educational environment for a real student. System 102 is connected to network 124, which is the Internet, a wide area network, a local area network, or other suitable network.

Environment 100 may include a client device 116. Client device 116 can include a laptop computer, desktop computer, tablet computer, smartphone, virtual reality (VR) headset, or other suitable computing device. Client device 116 may execute an application (app) for rendering a virtual learning environment. The virtual learning environment can be a web conference. The virtual learning environment can be a virtual reality environment. In some embodiments, a smartphone may be inserted into a wearable apparatus such as a VR smartphone headset in order to provide a virtual reality environment.

Environment 100 may include a web conferencing system 137. Web conferencing system 137 comprises one or more computing devices that renders a conferencing environment on client device 116. The web conferencing system 137 may enable video conferencing, audio conferencing, desktop sharing, instant messaging services, and/or other services and features to facilitate a virtual learning experience.

Environment 100 may include a virtual reality (VR) rendering system 112. VR rendering system 112 comprises one or more computing devices that renders a virtual environment such as a classroom, laboratory, library, or other suitable educational venue. VR rendering system 112 may utilize input data that includes input from a real student that is using virtual reality hardware such as a virtual reality headset. In some embodiments, hand-held controllers may also be used in conjunction with a VR headset.

Environment 100 may include a generic knowledge corpus 119. The generic knowledge corpus can include a database or other information retrieval system that includes information about a variety of educational topics, as well as level-appropriate information regarding each topic. In this way, level-appropriate virtual learning can be achieved. As an example, a third-grade student is presented with virtual learning appropriate for a third-grade student.

Environment 100 may include a personalized knowledge corpus 114. The personalized knowledge corpus 114 may include information regarding a particular student. The information may be stored in one or more data structures that comprise a student profile. The student profile can include information such as names, nicknames, personality type, learning preferences, and/or other pertinent information for a particular real student.

Environment 100 further includes machine learning system 122. Machine learning system 122 may be used to further categorize and classify input data including natural language processing (NLP) of speech utterances and/or written responses from a real student, object recognition and/or object classification, person recognition, and/or other classification processes. Machine learning system 122 may include one or more neural networks 123, which can include convolutional neural networks (CNNs), and/or other deep learning techniques. Machine learning system 122 may be trained with supervised and/or unsupervised learning techniques. The machine learning system 122 may include regression algorithms, classification algorithms, clustering techniques, anomaly detection techniques, Bayesian filtering, and/or other suitable techniques to analyze the information provided by the VSM system 102 to assist in creating virtual students for insertion into a virtual environment for educational purposes. The VSM may orchestrate virtual student interactions. Virtual student interactions include a virtual student communicating with a real student. The communication can include audio and/or written communication. Virtual student interactions include a virtual student communicating with another virtual student. In some instances, this feature can be used to help foster participation by a real student. As an example, a real student who is introverted may be hesitant to participate in a group activity. In this situation, the VSM system 102 may detect a low level of engagement from the real student. The low level of engagement can be detected based on keystroke activity, eye tracking, utterances, and/or other activity. The virtual student interactions can be executed based on, and/or in response to, actions of the real student. These actions can include providing a response/answer to a question regarding a virtual lesson. In embodiments, executing a virtual student interaction is performed with machine learning. In embodiments, the machine learning includes a neural network. The neural network may include multiple layers, including hidden layers.

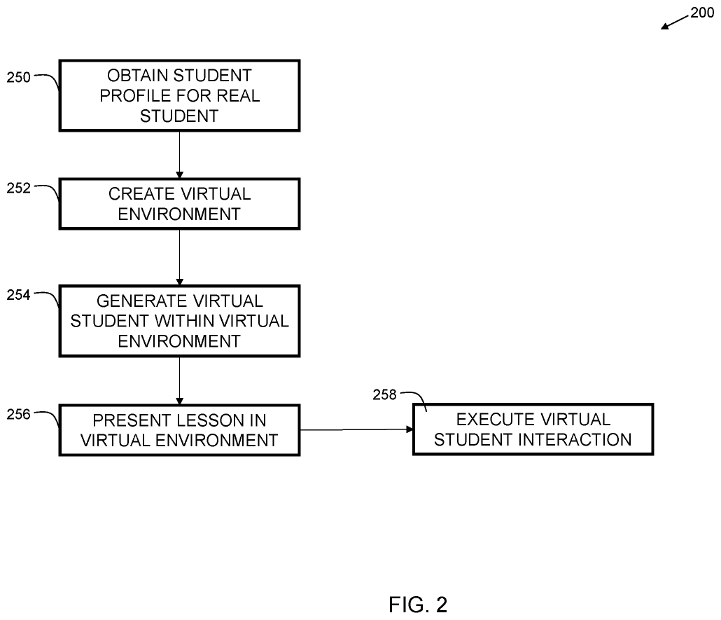

FIG. 2 is a flowchart 200 indicating process steps for embodiments of the present invention. At 250, a student profile is obtained for a real student. The student profile may include information such as a student name, user identifier, preferred group size, personality type, learning style, subject proficiency, age, gender, medical diagnoses, and/or other pertinent information regarding the real student. In some embodiments, more, fewer, or other data may be included in the student profile. At 252, a virtual environment is created. This can include creating a virtual reality environment. The virtual reality environment may resemble a classroom, laboratory, lecture hall, or other suitable environment. At 254, one or more virtual students are generated within the virtual environment. In embodiments, the number and type of virtual students may be based on the student profile obtained at 250. As an example, if the profile indicates that a real student prefers a group size of three to five people, then three or four virtual students may be generated. Similarly, if the profile indicates that a real student prefers a group size of eight to ten people, then additional virtual students may be generated, in order to provide the environment that maximizes learning potential for the real student. At 256, a lesson is presented to the real student in the virtual environment. The lesson can be on a variety of subjects, such as math, science, English, foreign language instruction, history, social studies, and more. Furthermore, lessons can transcend pure academic subjects, and include skills teaching such as computer skills, accounting, and other business or life skills. Games such as chess, checkers, and card games can also be taught using disclosed embodiments. At 258, a virtual student interaction is executed. The virtual student interaction can include communicating (via speech and/or text) to a real student. The communication can include a directive (command), statement, and/or a question to the real student. The virtual student interaction can include communicating (via speech and/or text) to another virtual student. The communication can include a directive, statement, and/or a question to the other virtual student. Some environments may also include a teacher. The teacher may be a real teacher or a virtual teacher. In those embodiments, the virtual student interaction can include communicating to the teacher (real or virtual). As the real student observes and/or receives interactions from the virtual students, the real student may increase his/her level of engagement in the lesson. Students that are generally shy and/or uncomfortable talking in a class setting may feel more comfortable after observing virtual student interactions.

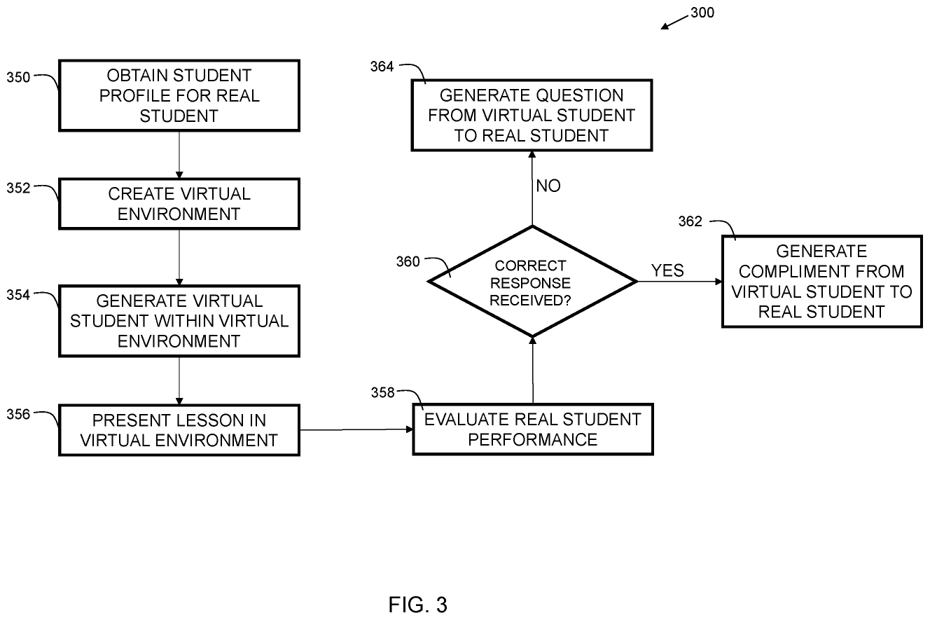

FIG. 3 is a flowchart 300 indicating additional process steps for embodiments of the present invention. At 350, a student profile is obtained for a real student. The student profile may include information such as a student name, user identifier, preferred group size, personality type, learning style, subject proficiency, age, gender, medical diagnoses, and/or other pertinent information regarding the real student. At 352, a virtual environment is created. This can include creating a virtual reality environment. The virtual reality environment may resemble a classroom, laboratory, lecture hall, or other suitable environment.

At 354, one or more virtual students are generated within the virtual environment. In embodiments, the number and type of virtual students may be based on the student profile obtained at 350. As an example, if the profile indicates that a real student prefers a group size of three to five people, then three or four virtual students may be generated. Similarly, if the profile indicates that a real student prefers a group size of eight to ten people, then additional virtual students may be generated, in order to provide the environment that maximizes learning potential for the real student. Every student has a different learning journey and a different learning style. Some students are visual learners, while some students prefer to learn through audio. Similarly, some students thrive in the classroom, and other students are solo learners who get distracted by large groups. Disclosed embodiments can address these different learning styles and preferences, enabling all types of students to obtain an effective and engaging educational experience.

At 356, a lesson is presented to the real student in the virtual environment. The lesson can be on a variety of subjects, such as math, science, English, foreign language instruction, history, social studies, and more. A lesson is instruction on a topic within the subject(s). The instruction may be provided by a real or virtual teacher, which may or may not have an avatar form. Furthermore, lessons can transcend pure academic subjects, and include skill teaching such as computer skills, accounting, and other business or life skills. Games such as chess, checkers, and card games can also be taught using disclosed embodiments.

At 358, real student performance is evaluated. In embodiments, this may be performed via online proficiency tests for the subject matter of the lesson presented at 356. The performance criteria may include a response to a question presented in the lesson. In some embodiments, the criteria may further include an amount of time needed by the real student to provide a response. At 360, a check is made to determine if a correct response is received from the real student. As an example, after being presented with a lesson, a real student may be given a question with multiple choice answers. If the user provides the correct answer (YES at 360), then the process continues to 362, where the virtual student issues a compliment to the real student. In embodiments, the VSM system 102 may generate the compliment, and direct the VR rendering system 112 to render the compliment in verbal and/or written form to the real student. If the user does not provide a correct answer (NO at 360), then the process continues to 364, where the virtual student issues a question to the real student. In embodiments, the VSM system 102 may generate the question, and direct the VR rendering system 112 to render the question in verbal and/or written form to the real student. In embodiments, the question from the virtual student can be used to cause the real student to rethink his/her previous steps in solving a problem, such as a math problem, for example. Compliments from virtual students can be used to reinforce successful problem solving exhibited by a real student. A wide variety of virtual student interactions are possible in disclosed embodiments.

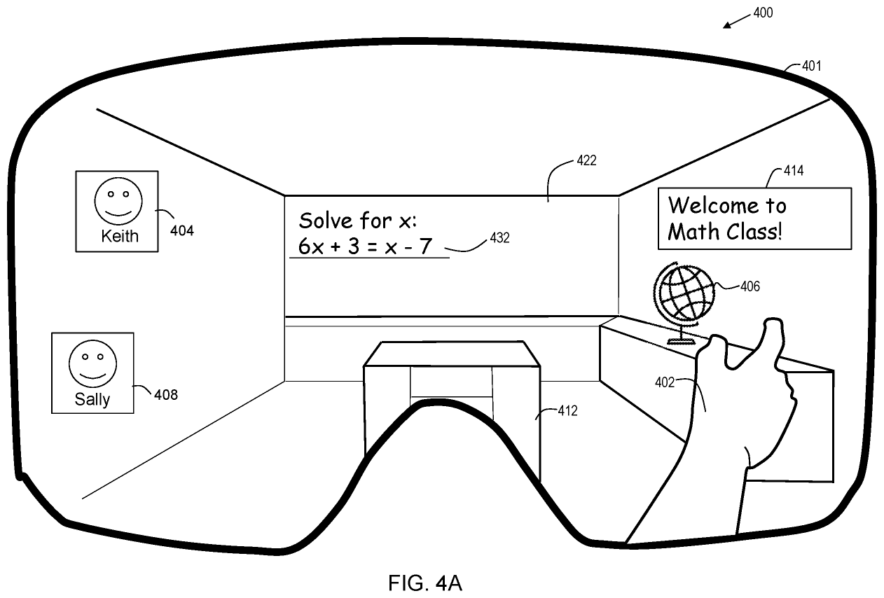

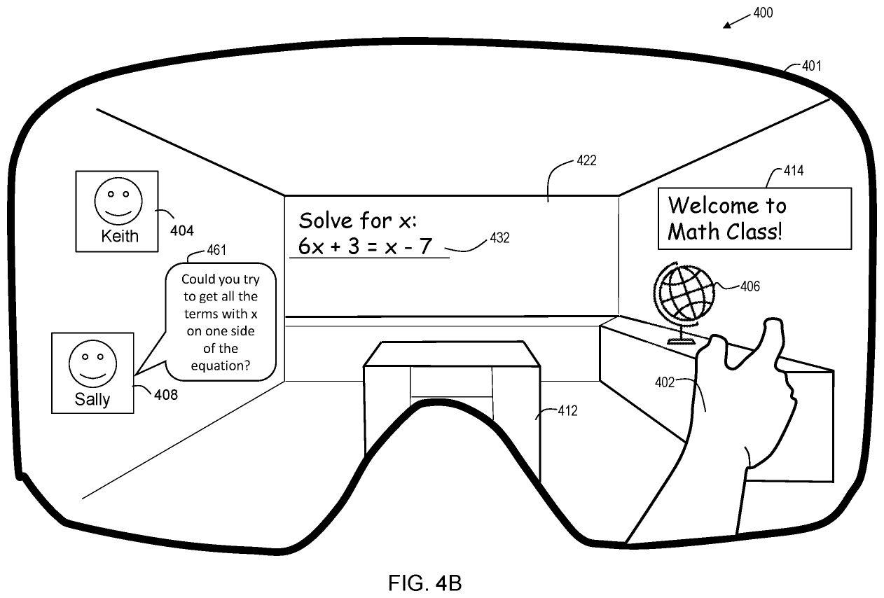

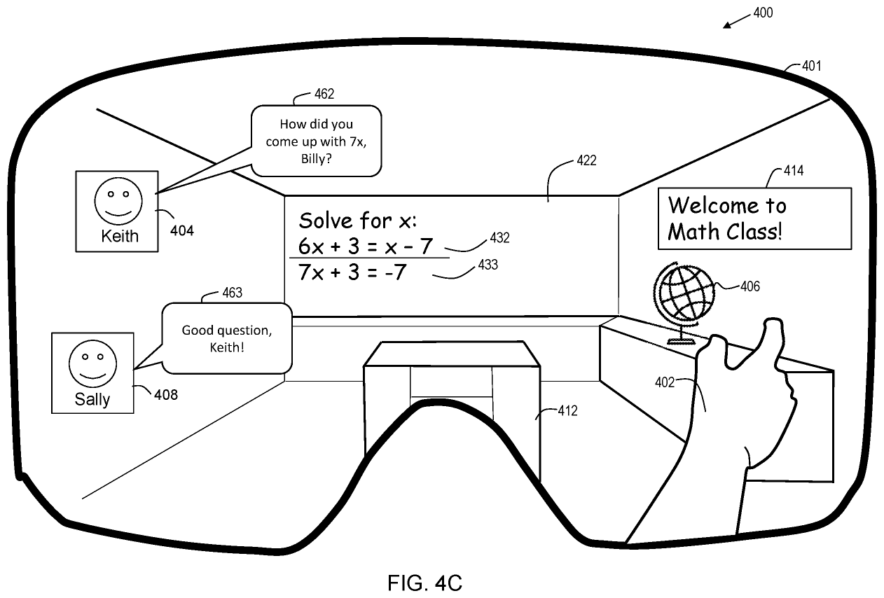

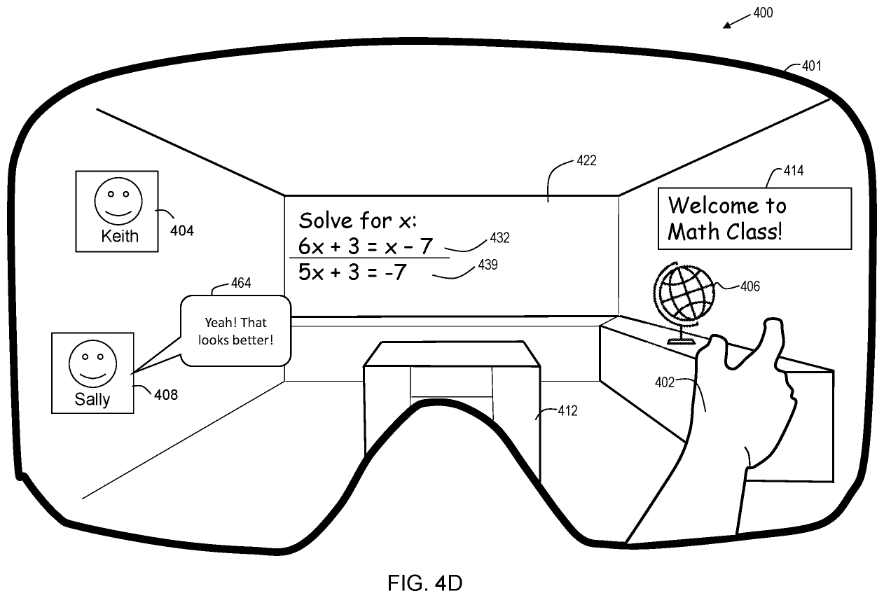

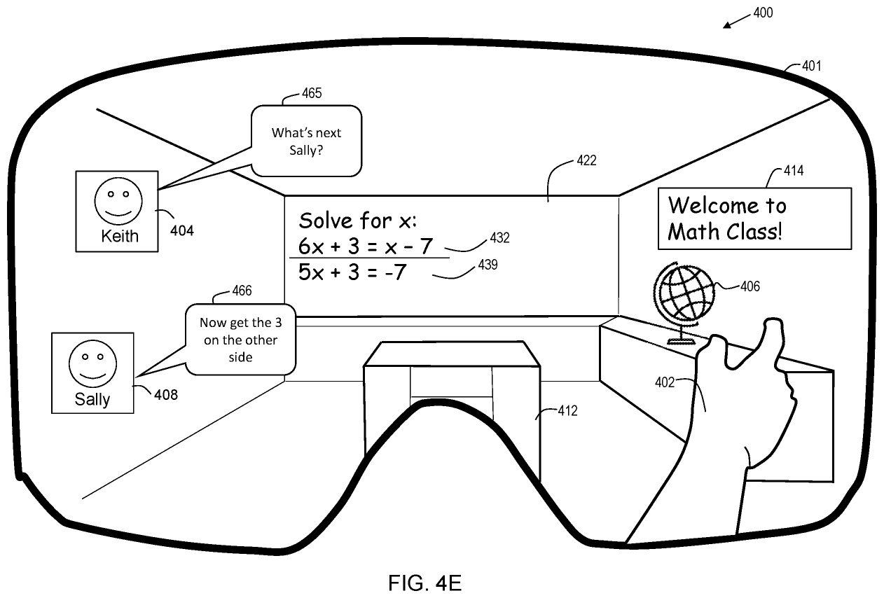

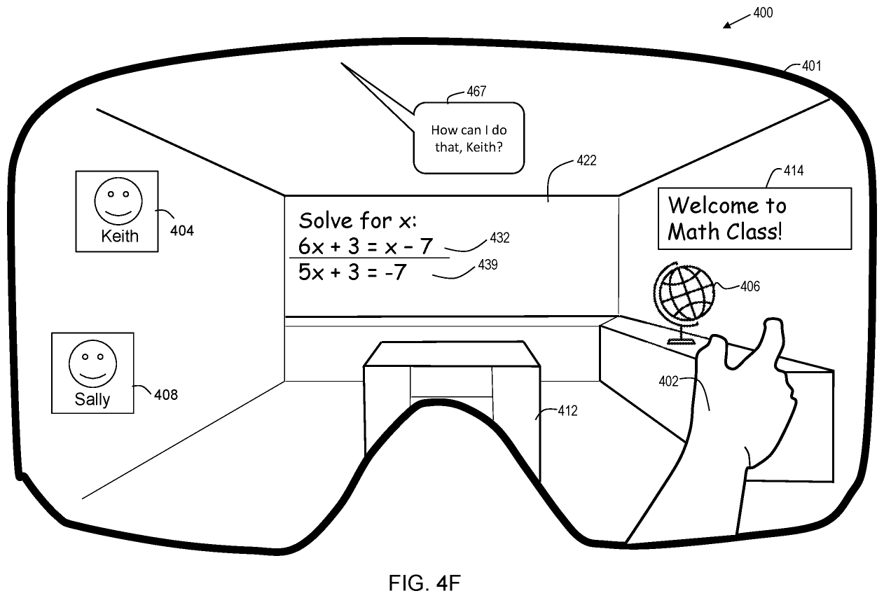

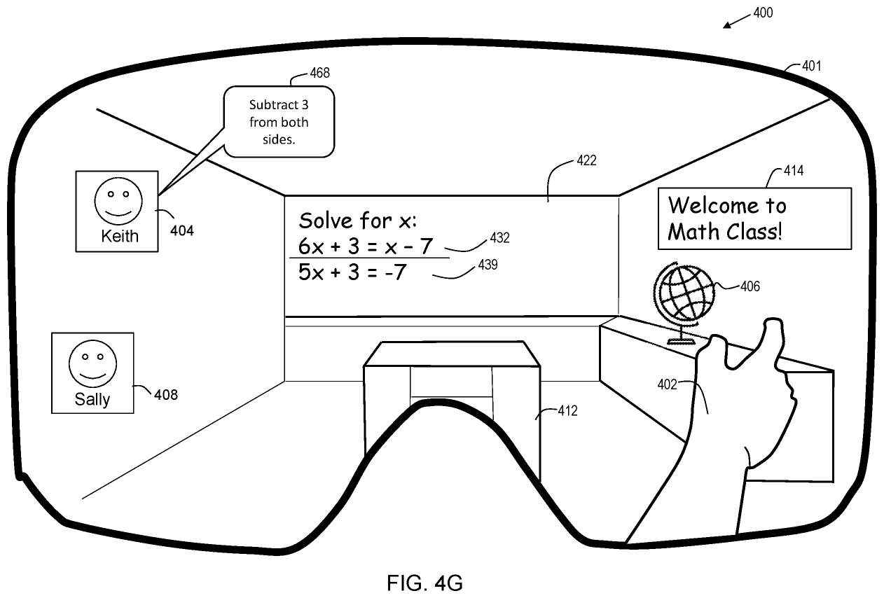

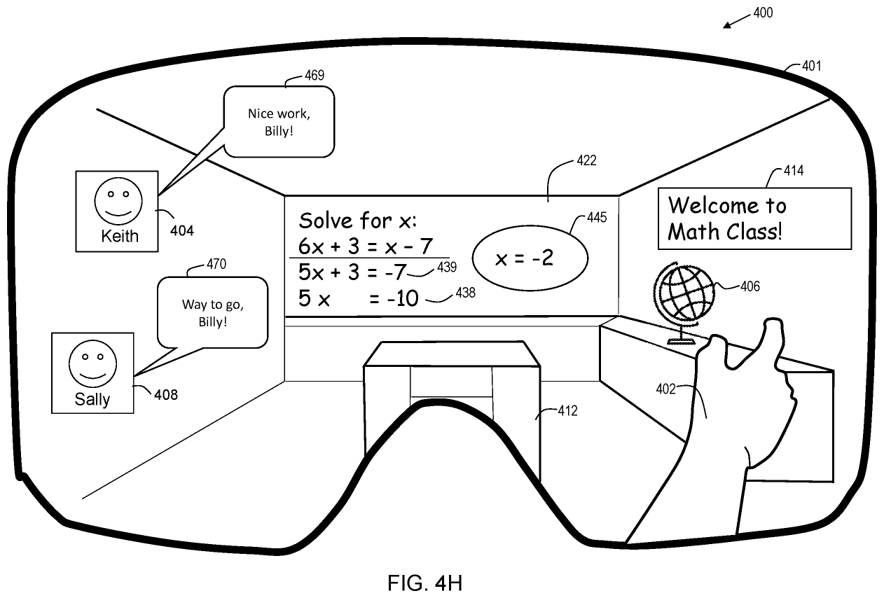

FIGS. 4A-4H illustrate examples of a virtual lesson. In the example illustrated in FIGS. 4A-4H, a real student “Billy” is in a virtual math class, along with two virtual students, indicated as Keith and Sally. The real student dons a virtual reality headset, providing him with the views shown in FIGS. 4A-4H. Referring now to FIG. 4A, the user, which is the real student “Billy,” enters a virtual environment 400 by donning virtual reality headset 401. The user sees a virtual environment that may include various objects, such as a desk 412, globe 406, and blackboard 422. In embodiments, the objects may be used to as decoration to help make the environment more familiar and comfortable for the real student. As an example, an elementary school classroom may be decorated with age-appropriate posters, whereas a high school chemistry classroom may have a poster of a periodic table of elements. The VSM system 102 may select various objects to be rendered by the VR rendering system 112 in order to generate an appropriate environment for the real student. The user may use his/her hand to control objects and/or interact with the virtual environment. In some embodiments, the user may hold a handheld controller that he/she manipulates to create movement of the virtual hand 402. In other embodiments, a camera mounted on the virtual reality headset 401 and/or in the physical area proximal to the user tracks hand movement of the user, and renders virtual hand 402 in the environment.

A banner 414, displayed within the virtual environment, shows the message, “Welcome to Math Class!” This serves to confirm to the real user what class he/she is in. Displayed on the virtual blackboard 422 is a math problem 432. Two virtual students, Keith 404 and Sally 408, are also in the virtual environment. In embodiments, the virtual students may be avatars. In some embodiments, the virtual students may be rendered with faces only. In other embodiments, the entire body of each of the virtual students may be rendered. Embodiments can include generating a second virtual student within the virtual environment. In embodiments, the virtual environment is rendered using a virtual reality headset.

Referring to FIG. 4B, the real student “Billy” attempts to solve the math problem indicated at 432, but after a predetermined duration, Billy has not performed any steps to solve the problem. After the predetermined duration, which in some embodiments, may range from 30 to 60 seconds, virtual student Sally 408 asks a question 461: “Could you try to get all the terms with x on one side of the equation?”

Referring now to FIG. 4C, the user (Billy) makes first attempt by writing the step indicated at 433. This may be performed by “writing” on the virtual blackboard 422 with his finger, using a stylus, speech-to-text, keyboard entry, or any other suitable technique. The step indicated at 433 is not correct for solving the problem indicated at 432. After a predetermined duration (e.g., 10 to 20 seconds), virtual student Keith 404 asks a question 462 that is directed to the real student: “How did you come up with 7x, Billy?” The second virtual student Sally 408 issues a compliment to the virtual student Keith 404. The compliment 463 states: “Good question, Keith!” The compliment from one virtual student to another virtual student can demonstrate teamwork and group dynamics that can help foster a positive learning experience for the real student. In embodiments, the question is in response to an incorrect response from the real student. In embodiments, a virtual student may issue a directive, question, and/or compliment to a second virtual student.

Referring now to FIG. 4D, the user (Billy) issued a correction at 439. In response, the virtual student Sally 408 issues a compliment 464: “Yeah! That looks better!” In some embodiments, the VSM system 102 may randomly assign a virtual student to issue a question, statement, directive, compliment, or other instruction and/or commentary, in order to provide a natural feeling of group dynamics and participation.

Referring now to FIG. 4E, after a predetermined duration (e.g., 5-15 seconds) without any real student activity, virtual student Keith 404 generates question 465 directed at another virtual student: “What's next Sally?” In response, virtual student 408 Sally provides a directive 466: “Now get the 3 on the other side.”

Referring to FIG. 4F, the real user (Billy) asks a question at 467 to one of the virtual students: “How can I do that, Keith?” In some embodiments, a microphone may detect utterances from the real user and convert them to a question using speech-to-text and natural language processing (NLP) techniques. In some cases, the real student may direct a question to a specific virtual student. In other cases, the question may not be directed to a specific student, in which case the VSM system 102 may randomly assign a virtual student to respond to the question.

Referring to FIG. 4G, in response to the question 467, virtual student Keith 404 issues a directive 468: “Subtract 3 from both sides.” Thus, in embodiments, the virtual student interaction includes a directive addressed to the real student.

Referring to FIG. 4H, the real student performs an additional step 438 based on the directive 468, and then derives the correct answer, indicated at 445. In response to detecting a correct answer from the real student, the VSM system 102 issues compliments that are issued by the virtual students. Virtual student Keith 404 provides compliment 469: “Nice work, Billy!” Virtual student Sally 408 provides compliment 470: “Way to go, Billy!” In this way, the real student receives positive reinforcement. In embodiments, the virtual student interaction includes a compliment addressed to the real student.

Disclosed embodiments create a safe environment without bullying and other negative behaviors that can occur in a real classroom. Furthermore, the communication style of the virtual students, and the number of virtual students, can be adjusted based on the profile of the real student. If a real student prefers a larger group, more virtual students can be generated. If a real student prefers a smaller group, fewer virtual students can be generated. While the aforementioned example shows a basic algebra lesson, disclosed embodiments can be used for a wide variety of subjects, and difficulty levels. The real students can range in age from young children through adulthood. In embodiments, the virtual students are rendered to appear to be of a similar age to the real student.

In some embodiments, two or more human students (real students) can participate in a lesson, in which case the VSM system 102 can evaluate each and every individual real student and accordingly the VSM system 102 dynamically determines if additional virtual students are required.

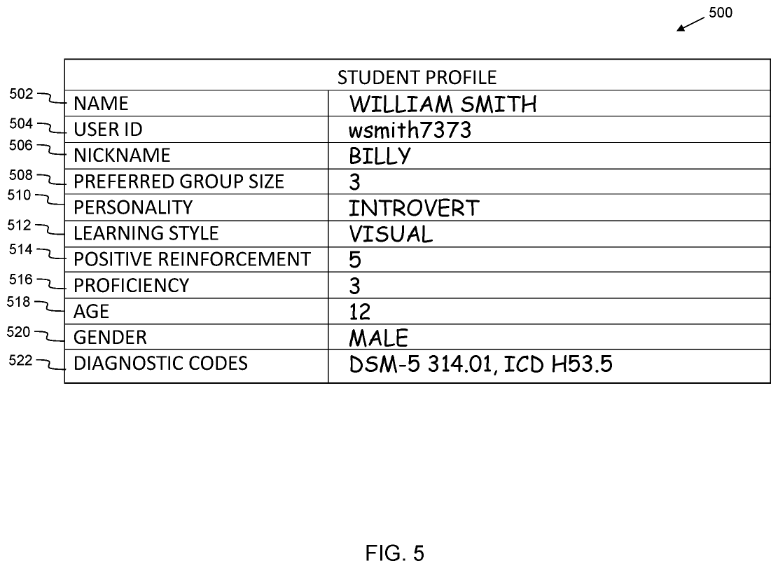

FIG. 5 shows a data structure 500 for a student profile in accordance with embodiments of the present invention. At field 502, a legal name for a user is provided. At field 504, a user identifier for the user is provided. At field 506, optionally, a nickname is provided. At field 508, a preferred group size is provided. The data for field 508 may be self-reported from the real student, or alternatively may be entered by another stakeholder such as a teacher or counselor that observes the student. At field 510, a personality type is provided. In embodiments, the personality type may be an enumerated type including values such as “introvert,” “extrovert,” and/or “ambivert.” At field 512, a learning style is provided. In embodiments, the learning style may be an enumerated type including values such as “visual,” “auditory,” and/or “tactile.” At field 514, a positive reinforcement value is provided. The positive reinforcement value may be a number indicating how much or little the student responds to positive reinforcement. In some embodiments, the value ranges between a minimum value of zero and a maximum value of ten, with the maximum value indicating a highest level of responsiveness to positive reinforcement, and the minimum value indicating a lowest level of responsiveness to positive reinforcement. The level of positive reinforcement may be used by the VSM system 102 to determine how frequently a virtual student issues compliments during a lesson. In some embodiments, more or fewer features may be included in the student profile.

At field 516, a proficiency value is provided. The proficiency value may be a number indicating how much or little the student knows about a particular subject matter. In some embodiments, the value ranges between a minimum value of zero and a maximum value of ten, with the maximum value indicating a highest level of proficiency, and the minimum value indicating a low level of proficiency. The level of proficiency may be used by the VSM system 102 to determine how frequently a virtual student interaction occurs during a lesson. At field 518, there is a field for an age of the student. The age value may be used as criteria by the VSM system 102 to instruct the VR rendering system 112 to render virtual students having an appearance of an age similar to that of the real student. Thus, a real third-grade student user sees virtual students that have an appearance that is in line with third graders. At field 520, there a gender value, indicating the gender of the student. The gender value may be used by the VSM system 102 to instruct the VR rendering system 112 to render virtual students identifying as the same gender as (or different gender from) the student.

At field 522, a list of diagnostic codes may be present. In some embodiments, each diagnostic code is represented as an alphanumeric string. The alphanumeric string can be a code from the Diagnostic and Statistical Manual of Mental Disorders (DSM-5), International Classification of Diseases (ICD), or other suitable classification system. The codes can be used by the VSM system 102 to create an environment that is well-suited for the learning style and needs of a real student. For example, a code of ICD H53.5 indicates a color vision deficiency. In response to obtaining this code, the VSM system 102 instructs the VR rendering system 112 to render a virtual environment using a color scheme that uses colors that the student can distinguish. The fields shown in data structure 500 are exemplary, and other embodiments may have more, fewer, or different fields than shows shown in FIG. 5.

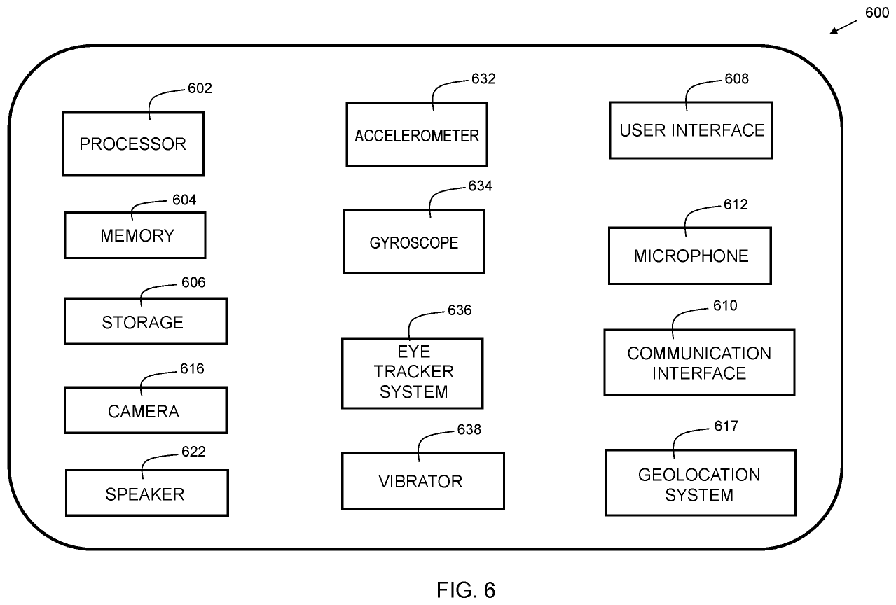

FIG. 6 is a block diagram of an example client device 600 used with embodiments of the present invention. In embodiments, this may represent a mobile electronic device such as 116 of FIG. 1. Device 600 is an electronic computation device. Device 600 includes a processor 602, which is coupled to a memory 604. Memory 604 may include dynamic random-access memory (DRAM), static random-access memory (SRAM), magnetic storage, and/or a read only memory such as flash, EEPROM, optical storage, or other suitable memory. In some embodiments, the memory 604 may not be a transitory signal per se. In some embodiments, device 600 may be a virtual reality headset. In some embodiments, device 600 may be a smartphone, or other suitable electronic computing device.

Device 600 may further include storage 606. In embodiments, storage 606 may include one or more magnetic storage devices such as hard disk drives (HDDs). Storage 606 may additionally include one or more solid state drives (SSDs).

Device 600 may, in some embodiments, include a user interface 608. This may include a display, keyboard, or other suitable interface. In some embodiments, the display may be touch-sensitive.

The device 600 further includes a communication interface 610. The communication interface 610 may include a wireless communication interface that includes modulators, demodulators, and antennas for a variety of wireless protocols including, but not limited to, Bluetooth™, Wi-Fi, and/or cellular communication protocols for communication over a computer network. In embodiments, instructions are stored in memory 604. The instructions, when executed by the processor 602, cause the electronic computing device 600 to execute operations in accordance with disclosed embodiments.

Device 600 may further include a microphone 612 used to receive audio input. The audio input may include speech utterances. The audio input may be digitized by circuitry within the device 600. The digitized audio data may be analyzed for phonemes and converted to text for further natural language processing. In some embodiments, the natural language processing may be performed onboard the device 600. In other embodiments, all or some of the natural language processing may be performed on a remote computer.

Device 600 may further include camera 616. In embodiments, camera 616 may be used to acquire still images and/or video images by device 600. Device 600 may further include one or more speakers 622. In embodiments, speakers 622 may include stereo headphone speakers, and/or other speakers arranged to provide an immersive sound experience. Device 600 may further include geolocation system 617. In embodiments, geolocation system 617 includes a Global Positioning System (GPS), GLONASS, Galileo, or other suitable satellite navigation system.

Device 600 may further include an accelerometer 632 and/or gyroscope 634. The accelerometer 632 and/or gyroscope 634 may be configured and disposed to track movements of a user, such as head and/or hand movements while donning wearable computing devices such as virtual reality headsets and/or hand-held remote-control devices in communication with a virtual reality system.

Device 600 may further include an eye tracker system 636. The eye tracker system 636 may include one or more cameras configured and disposed to track eye movement of a user, and render portions of a virtual environment based on eye movement. Device 600 may further include a vibrator 638 which may be used to provide tactile alerts to a student. Thus, embodiments can include generating haptic feedback in the virtual reality headset. These components are exemplary, and other devices may include more, fewer, and/or different components than those depicted in FIG. 6.

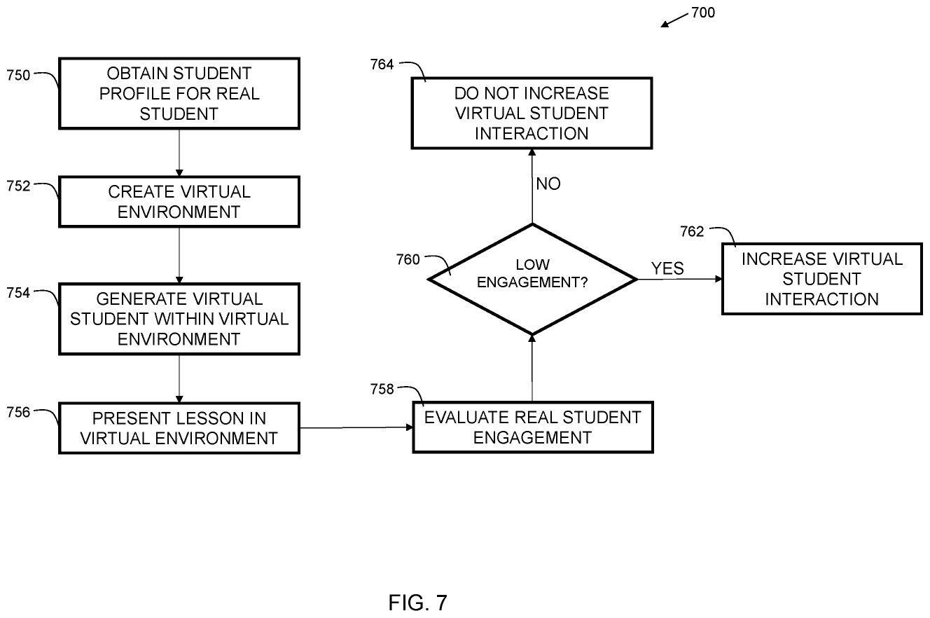

FIG. 7 is a flowchart 700 indicating additional process steps for embodiments of the present invention. At 750, a student profile is obtained for a real student. The student profile may include information such as a student name, user identifier, preferred group size, personality type, learning style, subject proficiency, age, gender, medical diagnoses, and/or other pertinent information regarding the real student. At 752, a virtual environment is created. This can include creating a virtual reality environment. The virtual reality environment may resemble a classroom, laboratory, lecture hall, or other suitable environment. At 754, one or more virtual students are generated within the virtual environment. In embodiments, the number and type of virtual students may be based on the student profile obtained at 750. As an example, if the profile indicates that a real student prefers a group size of three to five people, then three or four virtual students may be generated. Similarly, if the profile indicates that a real student prefers a group size of eight to ten people, then additional virtual students may be generated, in order to generate the environment that maximizes learning potential for the real student. At 756, a lesson is presented to the real student in the virtual environment. The lesson can be on a variety of subjects, such as math, science, English, foreign language instruction, history, social studies, and more. Furthermore, lessons can transcend pure academic subjects, and include skill teaching such as computer skills, accounting, and other business skills. Games such as chess, checkers, and card games can also be taught using disclosed embodiments.

At 758, real student engagement is evaluated. In embodiments, this may be performed by determining how often a real student asks a question, or participates in the lesson presented at 756. If the number of interactions of the real student is below a predetermined threshold, then the real student is deemed to have low engagement. At 760, a check is made to determine if the student has low engagement. If yes at 760, then the process continues to 762 where the interaction of virtual students is increased. This can include more questions, directives, compliments and/or comments from virtual students during a lesson. If no at 760, then at 764, the virtual student interaction is not increased. In some embodiments, more or fewer features than those shown and described may be included in the device.

As can now be appreciated, disclosed embodiments improve the technical field of virtual learning. Disclosed embodiments provide techniques for rendering virtual students that are tailored to a real student's interaction behavior and knowledge level. Furthermore, in embodiments, the VSM system monitors the real students learning behaviors and analyzes the learning type of the student as an auditory learner, visual learner, or tactile learner. Disclosed embodiments can include multiple stages of the learning process. Stage one can include observational analysis of student behavior. Stage two can include personalized collaborative learning analysis. Stage three can include rendering of virtual student environment for optimized collaboration. Stage four can include real-time evaluation and self-learning. Stage five can include interactive iterations for usage, personalized processing amelioration, and knowledge corpus feedback. Thus, a customized virtual learning experience is created based on the needs and preferences of the real student serving to make the learning experience fun and intuitive.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining a student profile for a real student;
creating a virtual environment;
generating a virtual student within the virtual environment;
presenting a lesson to the real student in the virtual environment; and
executing a virtual student interaction based on actions of the real student.

2. The method of claim 1, wherein the virtual student interaction includes a directive addressed to the real student.

3. The method of claim 1, wherein the virtual student interaction includes a question addressed to the real student.

4. The method of claim 1, wherein the virtual student interaction includes a compliment addressed to the real student.

5. The method of claim 3, wherein the question is in response to an incorrect response from the real student.

6. The method of claim 1, further comprising generating a second virtual student within the virtual environment.

7. The method of claim 6, wherein the virtual student interaction includes a directive addressed to the second virtual student.

8. The method of claim 6, wherein the virtual student interaction includes a question addressed to the second virtual student.

9. The method of claim 6, wherein the virtual student interaction includes a compliment addressed to the second virtual student.

10. The method of claim 1, wherein executing a virtual student interaction is performed with machine learning.

11. The method of claim 10, wherein the machine learning includes a neural network.

12. The method of claim 11, wherein the virtual environment is rendered using a virtual reality headset.

13. The method of claim 12, further comprising generating haptic feedback in the virtual reality headset.

14. An electronic computation device comprising:
a processor;
a memory coupled to the processor, the memory containing instructions, that
when executed by the processor, cause the electronic computation device to:
obtain a student profile for a real student;
create a virtual environment;
generate a virtual student within the virtual environment;
present a lesson to the real student in the virtual environment; and
execute a virtual student interaction based on actions of the real student.

15. The electronic computation device of claim 14, wherein the memory further comprises instructions, that when executed by the processor, cause the electronic computation device to execute the virtual student interaction via machine learning.

16. The electronic computation device of claim 15, wherein the memory further comprises instructions, that when executed by the processor, cause the electronic computation device to perform the machine learning via a neural network.

17. The electronic computation device of claim 16, wherein the memory further comprises instructions, that when executed by the processor, cause the electronic computation device to render the virtual environment on a virtual reality headset.

18. A computer program product for an electronic computation device comprising a computer readable storage medium having program instructions embodied therewith, the program instructions executable by a processor to cause the electronic computation device to:
obtain a student profile for a real student;
create a virtual environment;
generate a virtual student within the virtual environment;
present a lesson to the real student in the virtual environment; and
execute a virtual student interaction based on actions of the real student.

19. The computer program product of claim 18, wherein the computer program product further includes program instructions, that when executed by the processor, cause the electronic computation device to execute the virtual student interaction via machine learning.

20. The computer program product of claim 19, wherein the computer program product further includes program instructions, that when executed by the processor, cause the electronic computation device to perform the machine learning via a neural network.
